(19) United States
(12) Patent Application Publication
(10) Pub. No.: US 2025/0209907 A1
(43) Pub. Date: Jun. 26, 2025

(54) METHOD, APPARATUS AND COMPUTER PROGRAM PRODUCT FOR INTELLIGENT TRAFFIC DATA PROCESSING

(71) Applicant: HERE Global B.V., Eindhoven (NL)

(72) Inventors: Jingwei XU, Buffalo Grove, IL (US); Yuxin GUAN, Chicago, IL (US); Bruce BERNHARDT, Wauconda, IL (US); Weimin HUANG, Summit, NJ (US)

(73) Assignee: HERE Global B.V., Eindhoven (NL)

(21) Appl. No.: 18/392,970

(22) Filed: Dec. 21, 2023

(51) Int. Cl. G08G 1/01; G08G 1/052

(52) U.S. Cl. CPC G08G 1/0129; G08G 1/0112; G08G 1/0133; G08G 1/052

(57) ABSTRACT

Embodiments described herein may provide a method for establishing traffic patterns in an efficient manner. Methods include: receiving historical probe data associated with a road segment; generating traffic pattern data and short-term traffic pattern data for a plurality of periods of time for the road segment, where the traffic pattern data includes traffic patterns that are consistent with historical traffic patterns during a first period of time, and where short-term traffic pattern data includes traffic patterns that fluctuate relative to historical traffic patterns during a second period of time; receiving real-time probe data associated with the road segment during the first period of time and the second period of time; generating traffic data for the road segment using historical traffic pattern data for the first period of time; and generating real-time traffic data for the road segment using the real-time probe data received during the second period of time.

### TECHNOLOGICAL FIELD

An example embodiment of the present invention relates generally to determining traffic information along road segments, and more particularly, to a method, apparatus, and computer program product for efficient data processing to establish traffic patterns in a cost-effective manner.

### BACKGROUND

The advent of digital maps that include up-to-date dynamic data regarding conditions affecting travel within a geographic region has transformed the way in which people travel. Routing algorithms can determine the most efficient path from an origin to a destination at a given time and guide a user along the established route. Further, traffic information can be updated as a user travels along the route and can be provided to the user as needed. Beyond traffic data, weather data can be provided for geographic regions that can affect travel where the weather data can be used by a person to make informed decisions about where they are traveling. These technological developments have improved the efficiency with which people travel and can provide people with a reasonable estimate of their time of arrival at a destination.

The abundance of available data enables traffic information for road segments to be determined with a relatively high degree of accuracy. However, the volume of available data also renders the task computationally expensive while using considerable processing resources and bandwidth to process the available data.

### BRIEF SUMMARY

A method, apparatus, and computer program product are therefore provided for determining traffic information along road segments, and more particularly, to a method, apparatus, and computer program product for efficient data processing to establish traffic patterns in a cost-effective manner. Embodiments include an apparatus including at least one processor and at least one non-transitory memory including computer program code instructions, the computer program code instructions may be configured to, when executed, cause the apparatus to at least: receive historical probe data associated with a road segment of a plurality of road segments of a road network within a geographic region; generate, from the historical probe data, traffic pattern data and short-term traffic pattern data for a plurality of periods of time for the road segment, where the traffic pattern data includes traffic patterns that are consistent with historical traffic patterns along the road segment during a first period of time of the plurality of periods of time, and where short-term traffic pattern data includes traffic patterns that fluctuate relative to historical traffic patterns along the road segment during a second period of time; receive real-time probe data associated with the road segment of the road network during times associated with the first period of time and times associated with the second period of time; generate traffic data for the road segment using historical traffic pattern data for the times associated with the first period of time; and generate real-time traffic data for the road segment using the real-time probe data received during the times associated with the second period of time, where the traffic data and the real-time traffic data facilitate at least one of navigational guidance or at least semi-autonomous vehicle control along the road segment.

According to some embodiments, the probe data associated with the road segment is map-matched to the road segment of the plurality of road segments. The apparatus of an example embodiment is further caused to: determine at least one speed category for the road segment for each of the plurality of periods of time, where the traffic pattern data includes probe data for time periods of the plurality of periods of time that corresponds with the at least one speed category for a corresponding historical time period, and the short-term traffic pattern data includes probe data for time periods of the plurality of periods of time that does not correspond with the at least one speed category for a corresponding historical time period. According to certain embodiments, the at least one speed category is determined based, at least in part, on at least one of a road type or road functional class.

According to certain embodiments, the traffic pattern data for the road segment and the short-term traffic pattern data for the road segment each include a reliability index. According to some embodiments, the reliability index is an indication of a confidence that the traffic pattern data or the short-term traffic pattern data is an accurate reflection of historical stability of traffic patterns on the road segment. Causing the apparatus of some embodiments to generate the traffic pattern data and the short-term traffic pattern data includes aggregating continuous periods of time for the road segment for each of the traffic pattern data and the short-term traffic pattern data.

According to some embodiments, causing the apparatus to generate real-time traffic data for the road segment using the real-time probe data received during the times associated with the second period of time includes causing the apparatus to filter out real-time probe data associated with the first period of time associated with the traffic pattern data. According to some embodiments, the apparatus is further caused to: determine a reliability index of the traffic pattern data and a reliability index of the short-term traffic pattern data, and in response to the reliability index of the traffic pattern data being below a predetermined value, generate the traffic data for the road segment using the real-time probe data received during the times associated with the first period of time. According to certain embodiments, in response to the reliability index of the traffic pattern data being below the predetermined value, the apparatus is caused to regenerate the traffic pattern data for the first period of time.

Embodiments provided herein include a computer program product comprising at least one non-transitory computer-readable storage medium having computer-executable program code instructions stored therein, the computer-executable program code instructions including program code instructions to: receive historical probe data associated with a road segment of a plurality of road segments of a road network within a geographic region; generate, from the historical probe data, traffic pattern data and short-term traffic pattern data for a plurality of periods of time for the road segment, where the traffic pattern data includes traffic patterns that are consistent with historical traffic patterns along the road segment during a first period of time of the plurality of periods of time, and where short-term traffic pattern data includes traffic patterns that fluctuate relative to historical traffic patterns along the road segment during a second period of time; receive real-time probe data associated with the road segment of the road network during times associated with the first period of time and times associated with the second period of time; generate traffic data for the road segment using historical traffic pattern data for the times associated with the first period of time; and generate real-time traffic data for the road segment using the real-time probe data received during the times associated with the second period of time, where the traffic data and the real-time traffic data facilitate at least one of navigational guidance or at least semi-autonomous vehicle control along the road segment.

According to some embodiments, the probe data associated with the road segment is map-matched to the road segment of the plurality of road segments. The computer program product of an example embodiment further includes program code instructions to: determine at least one speed category for the road segment for each of the plurality of periods of time, where the traffic pattern data includes probe data for time periods of the plurality of periods of time that corresponds with the at least one speed category for a corresponding historical time period, and the short-term traffic pattern data includes probe data for time periods of the plurality of periods of time that does not correspond with the at least one speed category for a corresponding historical time period. According to certain embodiments, the at least one speed category is determined based, at least in part, on at least one of a road type or road functional class.

According to certain embodiments, the traffic pattern data for the road segment and the short-term traffic pattern data for the road segment each include a reliability index. According to some embodiments, the reliability index is an indication of a confidence that the traffic pattern data or the short-term traffic pattern data is an accurate reflection of historical stability of traffic patterns on the road segment. The program code instructions of some embodiments to generate the traffic pattern data and the short-term traffic pattern data includes program code instructions to aggregate continuous periods of time for the road segment for each of the traffic pattern data and the short-term traffic pattern data.

Embodiments provided herein include a method including: receiving historical probe data associated with a road segment of a plurality of road segments of a road network within a geographic region; generating, from the historical probe data, traffic pattern data and short-term traffic pattern data for a plurality of periods of time for the road segment, where the traffic pattern data includes traffic patterns that are consistent with historical traffic patterns along the road segment during a first period of time of the plurality of periods of time, and where short-term traffic pattern data includes traffic patterns that fluctuate relative to historical traffic patterns along the road segment during a second period of time; receiving real-time probe data associated with the road segment of the road network during times associated with the first period of time and times associated with the second period of time; generating traffic data for the road segment using historical traffic pattern data for the times associated with the first period of time; and generating real-time traffic data for the road segment using the real-time probe data received during the times associated with the second period of time, where the traffic data and the real-time traffic data facilitate at least one of navigational guidance or at least semi-autonomous vehicle control along the road segment.

According to some embodiments, the probe data associated with the road segment is map-matched to the road segment of the plurality of road segments. The method of an example embodiment further includes: determining at least one speed category for the road segment for each of the plurality of periods of time, where the traffic pattern data includes probe data for time periods of the plurality of periods of time that corresponds with the at least one speed category for a corresponding historical time period, and the short-term traffic pattern data includes probe data for time periods of the plurality of periods of time that does not correspond with the at least one speed category for a corresponding historical time period. According to certain embodiments, the at least one speed category is determined based, at least in part, on at least one of a road type or road functional class.

According to certain embodiments, the traffic pattern data for the road segment and the short-term traffic pattern data for the road segment each include a reliability index. According to some embodiments, the reliability index is an indication of a confidence that the traffic pattern data or the short-term traffic pattern data is an accurate reflection of historical stability of traffic patterns on the road segment. The method of some embodiments for generating the traffic pattern data and the short-term traffic pattern data includes aggregating continuous periods of time for the road segment for each of the traffic pattern data and the short-term traffic pattern data.

Embodiments provided herein include an apparatus including: means for receiving historical probe data associated with a road segment of a plurality of road segments of a road network within a geographic region; means for generating, from the historical probe data, traffic pattern data and short-term traffic pattern data for a plurality of periods of time for the road segment, where the traffic pattern data includes traffic patterns that are consistent with historical traffic patterns along the road segment during a first period of time of the plurality of periods of time, and where short-term traffic pattern data includes traffic patterns that fluctuate relative to historical traffic patterns along the road segment during a second period of time; means for receiving real-time probe data associated with the road segment of the road network during times associated with the first period of time and times associated with the second period of time; means for generating traffic data for the road segment using historical traffic pattern data for the times associated with the first period of time; and means for generating real-time traffic data for the road segment using the real-time probe data received during the times associated with the second period of time, where the traffic data and the real-time traffic data facilitate at least one of navigational guidance or at least semi-autonomous vehicle control along the road segment.

According to some embodiments, the probe data associated with the road segment is map-matched to the road segment of the plurality of road segments. The apparatus of an example embodiment further includes: means for determining at least one speed category for the road segment for each of the plurality of periods of time, where the traffic pattern data includes probe data for time periods of the plurality of periods of time that corresponds with the at least one speed category for a corresponding historical time period, and the short-term traffic pattern data includes probe data for time periods of the plurality of periods of time that does not correspond with the at least one speed category for a corresponding historical time period. According to certain embodiments, the at least one speed category is determined based, at least in part, on at least one of a road type or road functional class.

According to certain embodiments, the traffic pattern data for the road segment and the short-term traffic pattern data for the road segment each include a reliability index. According to some embodiments, the reliability index is an indication of a confidence that the traffic pattern data or the short-term traffic pattern data is an accurate reflection of historical stability of traffic patterns on the road segment. The means for generating the traffic pattern data and the short-term traffic pattern data includes means for aggregating continuous periods of time for the road segment for each of the traffic pattern data and the short-term traffic pattern data.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings which are not necessarily drawn to scale, and wherein:

FIG. 1 is a block diagram of a vehicular traffic system according to an example embodiment of the present disclosure;

FIG. 2 is a block diagram of an apparatus according to an example embodiment of the present disclosure;

FIG. 3 is a block diagram of a system for establishing traffic patterns in a cost-effective manner according to an example embodiment of the present disclosure;

FIG. 4 illustrates a visual example of a single day for a plurality of road segments identified by their road segment identifiers according to an example embodiment of the present disclosure;

FIG. 5 illustrates a road segment that moves between a stable time to an unstable time according to an example embodiment of the present disclosure;

FIG. 6 illustrates an example embodiment of an intelligent traffic processing system employing the process described herein for identifying stable and unstable road segments for improving the efficiency of traffic data processing according to an example embodiment of the present disclosure; and

FIG. 7 is a flowchart of another method for establishing traffic patterns in an efficient manner according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment of the present disclosure for determining traffic information along road segments, and more particularly, to a method, apparatus, and computer program product for efficient data processing to establish traffic patterns in a cost-effective manner. Autonomous vehicle control and navigational assistance along a network of roads is facilitated by an understanding of traffic patterns and traffic volumes along road segments and through intersections.

Traffic service providers provide real-time traffic flow and incident information by taking vehicle probe data, traffic history pattern data, and map data using streaming processing technology. This process can be resource intensive as there is an ever-increasing volume of available data regarding travel along road segments of a road network. If there is vehicle probe data coverage available on a road segment, historical traffic pattern data is used only to blend with past traffic information as traffic flow data for routing and navigation travel time calculation. To establish traffic patterns and to generate historic traffic patterns, systems process vehicle probe data continuously every hour of every day without interruption and across all regions of a road network for all road segments, regardless of road segment volume or length as long as a customer requires it. This type of data processing requires vast processing resources employing hundreds of virtual machines crossing different data centers and regions, in addition to the vast volumes of storage or memory required. This resource consumption results in large financial expenses.

Embodiments described herein provide a process of substantially reducing the processing capacity and bandwidth required, along with a substantial reduction in memory and costs associated with generating and maintaining accurate traffic information for a road network. Embodiments employ batch processing to review the average speed values for the typical day and provides complete projections on drive times based on billions of data points gathered from multiple years of vehicle speed observations including GPS (Global Positioning System) probe data records. Traffic pattern data for road segments can be generated for fixed time intervals (e.g., every 15 minutes) and fixed road geometries (e.g., via road link/segment identifiers). From this information, traffic pattern (TP) data and short-term traffic pattern (STP) data is generated.

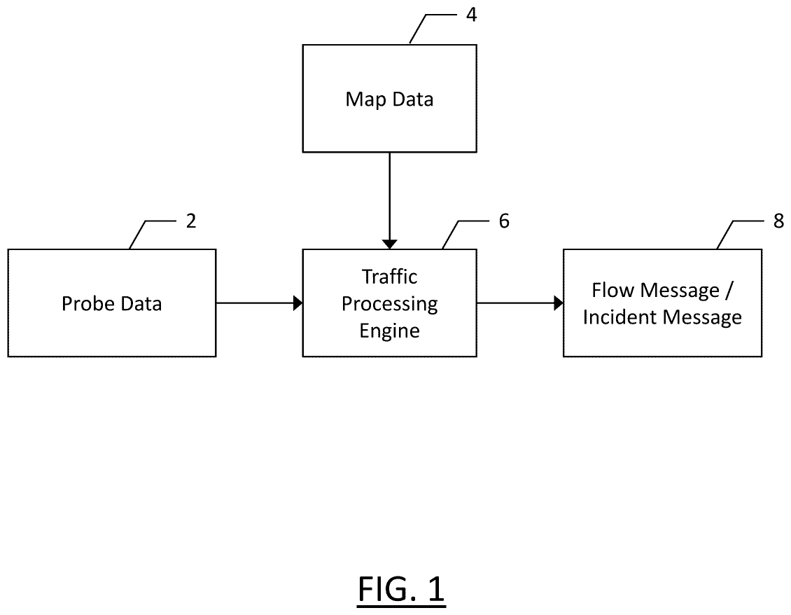

Embodiments provided by the present disclosure generate adjustable dynamic traffic pattern flow for new vehicular traffic processing systems. In traffic systems, probe data from multiple resources are used as input and output is flow or incident information/messages through the processing engine as shown in FIG. 1. The probe data 2, which can include a wide variety of information, but generally has at least a location (e.g., latitude and longitude) and a time (e.g., a timestamp) representing a location of a vehicle at the timestamp. Probe data 2 can include significantly more information in some cases, such as a probe identifier, a vehicle travel speed, a heading direction, or other information that the probe is able to collect and transmit. The probe data 2 is used as an input to the traffic processing engine 6, which also receives map data 4 describing road segment geometry. The traffic processing engine 6 can, in some embodiments, map-match the probe data to the map data if the probe data is not already map-matched. Using the map data 4 and the probe data 2, the traffic processing engine 6 can generate flow messages and/or incident messages 8 that relate to traffic speed and flow along road segments of the road network.

The flow message and/or incident message 8 can be delivered to end customers using over the air radio interfaces or via network connection, such as an internet connection. The inputs of the probe data 2 can include real time probe data received from mobile devices or probe vehicles traveling among the road network. The map data 4 can include map artifact data which describes the road segment topology and geometry for the road network. Upon receiving the real time probe data, the traffic system engine 6 ingests the probe data, performs operations such as map matching, pathing, etc., then outputs an estimate of the current travel speed for a given road segment. The road segment may be described based on a road link identifier or on using an identifier of an established standard, such as the TMC (Traffic Message Channel) code that identifies the road segment. Based on the output speed category the road condition can be further described as free flow, queueing, stationary, etc. From a user perception perspective, driving speed equal to or lower than queueing speed is considered road or traffic congestion. The output speed category can vary depending upon the type of road or road classification along with a speed limit of the road segment. As an example, average speeds of 60 or more miles per hour on a highway would be considered free flow, while speeds under 35 miles per hour may be considered queueing. Average speeds of around 35 miles per hour on a suburban connector road or neighborhood road may be considered free flow.

Traffic patterns are determined using batch processing to review the average speed values for a typical day and provides complete projections on drive times based on billions of data points gathered from multiple-year vehicle speed observations, including GPS probe data records. Traffic pattern data may be generated for fixed time intervals (e.g., every 15 minutes) or fixed road geometry (e.g., TMC, road segment identifier, etc.). Further, to handle changes within a road network more accurately, such as traffic volumes significantly changing during a pandemic and different traffic flows between different seasons, short term traffic pattern data is generated with a higher refresh frequency. These updates can be used to provide more accurate travel times based on realistic, historical traffic speeds.

Embodiments described herein employ an intelligent method of traffic data processing using batch processing and using traffic pattern data to detect region and time as a smart filter for the traffic processing engine to calculate flow or detect congestion events on a road segment. Embodiments provide a method, apparatus, and computer program product to generate dynamic traffic pattern data and a reliability index in both spatial and temporal planes while maintaining a high-quality traffic product. Further, based on the dynamic traffic pattern data, short-term traffic pattern data, and reliability index data, a new traffic processing system can be designed to selectively process the unreliable road segments associated with the traffic pattern data and short-term traffic pattern data. For reliable traffic pattern and short-term traffic pattern data in some connected road segments, it may not be necessary to process probe data for flow generation, as traffic pattern and short-term traffic pattern data can be used instead.

Embodiments described herein provide for at least semi-autonomous vehicle control and/or navigational assistance using traffic data that is generated in an efficient and cost-effective manner while retaining accuracy. Embodiments enable a routing engine, navigational guidance, or autonomous vehicle control that considers traffic levels along road segments when determining routes to take and safe speeds for traversal of road segments.

In example embodiments, a navigation system user interface may be provided for driver assistance for a user traveling along a network of roadways. Optionally, embodiments described herein may provide assistance for autonomous or semi-autonomous vehicle control. Autonomous vehicle control may include driverless vehicle capability where all vehicle functions are provided by software and hardware to safely drive the vehicle along a path identified by the vehicle. Semi-autonomous vehicle control may be any level of driver assistance from adaptive cruise control to lane-keep assist, or the like. Autonomous vehicle control is defined by six levels of vehicle autonomy established by the Society of Automotive Engineers (SAE). Level zero is a fully manual vehicle driven by a person with no systems that guide the vehicle. Level five is a fully autonomous vehicle where the vehicle performs all driving tasks under all conditions, where there is zero human attention or interaction involved. Embodiments described herein can be employed in any of these levels of autonomy as with level zero, navigational assistance can be provided by a device that a user interprets and drives a vehicle with the aid of the navigational information. For level five or any level of at least some autonomy, embodiments can provide guidance or physically guide a vehicle along a path with an understanding of the traffic levels along that path.

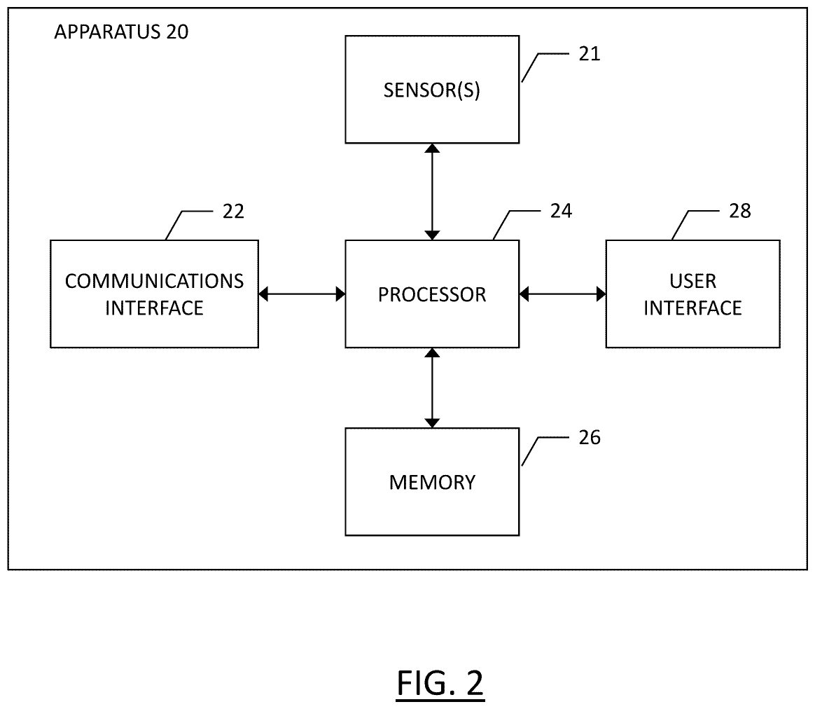

FIG. 2 is a schematic diagram of an example apparatus configured for performing any of the operations described herein. Apparatus 20 is an example embodiment that may be embodied by or associated with any of a variety of computing devices that include or are otherwise associated with a device configured to provide navigational guidance or at least semi-autonomous vehicle control through a road network. For example, the computing device may be an advanced driver assistance system (ADAS), a mobile terminal, such as a personal digital assistant (PDA), mobile telephone, smart phone, personal navigation device, smart watch, tablet computer, camera or any combination of the aforementioned and other types of voice and text communications systems. Optionally, the computing device may be a fixed computing device, such as a built-in vehicular navigation device, assisted driving device, or the like.

Optionally, the apparatus may be embodied by or associated with a plurality of computing devices that are in communication with or otherwise networked with one another such that the various functions performed by the apparatus may be divided between the plurality of computing devices that operate in collaboration with one another.

The apparatus 20 may be equipped with any number of sensors 21, such as a global positioning system (GPS), Light Distancing and Ranging (LiDAR) sensor, humidity sensor, image capture sensor, precipitation sensor, accelerometer, and/or gyroscope. Any of the sensors may be used to sense information regarding the movement, positioning, or orientation of the device and for determining a weather condition at the location of the device as described herein according to example embodiments. In some example embodiments, such sensors may be implemented in a vehicle or other remote apparatus, and the information detected may be transmitted to the apparatus 20, such as by near field communication (NFC) including, but not limited to, Bluetooth™ communication, or the like.

The apparatus 20 may include, be associated with, or may otherwise be in communication with a communication interface 22, processor 24, a memory device 26 and a user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 24 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 24 may be configured to execute instructions stored in the memory device 26 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 28. The user interface may include a touch screen display, a speaker, physical buttons, and/or other input/output mechanisms. In an example embodiment, the processor 24 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 26, and/or the like). In this regard, the apparatus 20 may interpret sensed data as certain weather conditions and establish location based on other sensor data, such as GPS data, for providing weather condition information for a specific location, for example.

The apparatus 20 of an example embodiment may also optionally include a communication interface 22 that may be any means such as a device or circuitry embodied in either hardware or a combination of hardware and software that is configured to receive and/or transmit data from/to other electronic devices in communication with the apparatus, such as by NFC, described above. Additionally or alternatively, the communication interface 22 may be configured to communicate over Global System for Mobile Communications (GSM), such as but not limited to Long Term Evolution (LTE). In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication may alternatively support vehicle to vehicle or vehicle to infrastructure wireless links.

According to certain embodiments, the apparatus 20 may support a mapping or navigation application so as to present maps or otherwise provide navigation or driver assistance. In order to support a mapping application, the computing device may include or otherwise be in communication with a geographic database, such as may be stored in memory device 26. For example, the geographic database includes node data records, road segment or link data records, point of interest (POI) data records, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology may be used, such as electronic horizon sensors, radar, LIDAR, ultrasonic and/or infrared sensors.

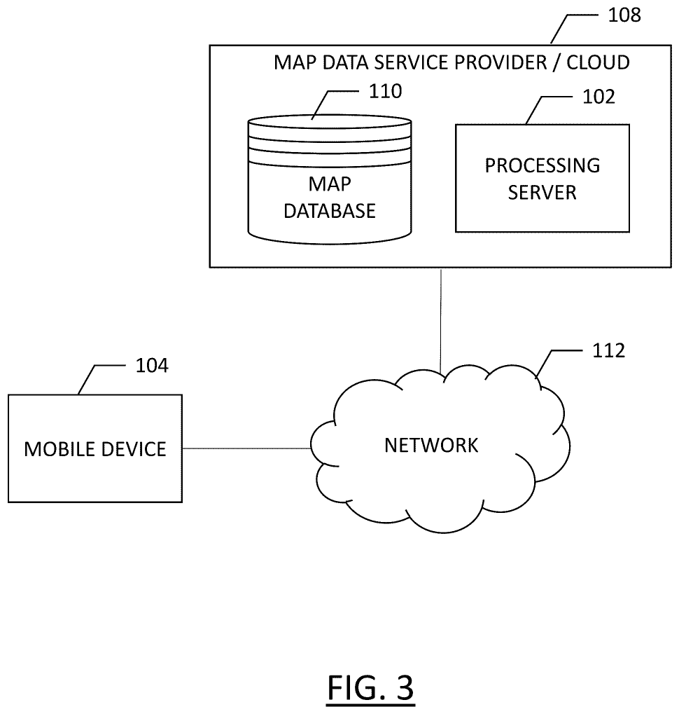

In example embodiments, a user device user interface and/or navigation system user interface may be provided to provide information or driver assistance to a user traveling along a network of roadways. According to example embodiments, map service provider database may be used to provide driver assistance via a navigation system and/or through at least semi-autonomous vehicle control. FIG. 3 illustrates a communication diagram of an example embodiment of a system for implementing example embodiments described herein using a navigation system and a map data service provider. The illustrated embodiment of FIG. 3 includes a mobile device 104, which may be, for example, the apparatus 20 of FIG. 2, such as a mobile phone, an in-vehicle navigation system, an advanced driver assistance system (ADAS), or the like, and a map data service provider or cloud service 108. Each of the mobile device 104 and map data service provider 108 may be in communication with at least one of the other elements illustrated in FIG. 3 via a network 112, which may be any form of wireless or partially wireless network as will be described further below. Additional, different, or fewer components may be provided. For example, many mobile devices 104 may connect with the network 112. The map data service provider 108 may be cloud-based services and/or may operate via a hosting server that receives, processes, and provides data to other elements of the system.

The map data service provider may include a map database 110 that may include node data, road segment data or link data, point of interest (POI) data, traffic data or the like. The map database 110 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 110 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 110 can include data about the POIs and their respective locations in the POI records. The map database 110 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 110 can include event data (e.g., traffic incidents, construction activities, scheduled events, unscheduled events, etc.) associated with the POI data records or other records of the map database 110.

The map database 110 may be maintained by a content provider e.g., the map data service provider and may be accessed, for example, by the content or service provider processing server 102. By way of example, the map data service provider can collect geographic data and dynamic data to generate and enhance the map database 110 and dynamic data such as traffic-related data or location-based hazard warning data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LIDAR, can be used to generate map geometries directly or through machine learning as described herein. However, the most ubiquitous form of data that may be available is vehicle data provided by vehicles, such as mobile device 104, as they travel the roads throughout a region. These vehicles or probes may be embodied by mobile device 104 and may provide data to the map data service provider in the form of traffic speed/congestion data, weather information, location, speed, direction, etc.

The map database 110 may be a master map database stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 104, for example. The navigation-related functions can correspond to vehicle navigation, pedestrian navigation, or other types of navigation. While example embodiments described herein generally relate to vehicular travel along roads, example embodiments may be implemented for pedestrian travel along walkways, bicycle travel along bike paths, boat travel along maritime navigational routes, etc. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map data service provider 108 map database 110 may be a master geographic database, but in alternate embodiments, a client-side map database may represent a compiled navigation database that may be used in or with end user devices (e.g., mobile device 104) to provide navigation and/or map-related functions. For example, the map database 110 may be used with the mobile device 104 to provide an end user with navigation features. In such a case, the map database 110 can be downloaded or stored on the end user device which can access the map database 110 through a wireless or wired connection, such as via a processing server 102 and/or the network 112, for example.

In one embodiment, as noted above, the end user device or mobile device 104 can be embodied by the apparatus 20 of FIG. 2 and can include an Advanced Driver Assistance System (ADAS) which may include an infotainment in-vehicle system or an in-vehicle navigation system, and/or devices such as a personal navigation device (PND), a portable navigation device, a cellular telephone, a smart phone, a personal digital assistant (PDA), a watch, a camera, a computer, and/or other device that can perform navigation-related functions, such as digital routing and map display. An end user can use the mobile device 104 for navigation and map functions such as guidance and map display, for example, and for determination of useful driver assistance information, according to some example embodiments. An embodiment implemented as an ADAS may at least partially control autonomous or semi-autonomous features of a vehicle with the assistance of establishing the vehicle.

An ADAS may be used to improve the comfort, efficiency, safety, and overall satisfaction of driving. Examples of such advanced driver assistance systems include semi-autonomous driver assistance features such as adaptive headlight aiming, adaptive cruise control, lane departure warning and control, curve warning, speed limit notification, hazard warning, predictive cruise control, adaptive shift control, among others. Other examples of an ADAS may include provisions for fully autonomous control of a vehicle to drive the vehicle along a road network without requiring input from a driver. Some of these advanced driver assistance systems use a variety of sensor mechanisms in the vehicle to determine the current state of the vehicle and the current state of the roadway ahead of the vehicle. These sensor mechanisms may include radar, infrared, ultrasonic, and vision-oriented sensors such as image sensors and light distancing and ranging (LiDAR) sensors.

Some advanced driver assistance systems may employ digital map data. Such systems may be referred to as map enhanced ADAS. The digital map data can be used in advanced driver assistance systems to provide information about the road network, road geometry, road conditions, and other information associated with the road and environment around the vehicle. Unlike some sensors, the digital map data is not affected by the environmental conditions such as fog, rain, or snow. Additionally, the digital map data can provide useful information that cannot reliably be provided by sensors, such as curvature, grade, bank, speed limits that are not indicated by signage, lane restrictions, and so on. Further, digital map data can provide a predictive capability well beyond the driver's vision to determine the road ahead of the vehicle, around corners, over hills, or beyond obstructions. Accordingly, the digital map data can be a useful and sometimes necessary addition for some advanced driving assistance systems. In the example embodiment of a fully autonomous vehicle, the ADAS uses the digital map data to determine a path along the road network to drive, such that accurate representations of the road are necessary, such as accurate representations of intersections and turn maneuvers there through. According to example embodiments described herein, this includes representations of traffic levels along road segments as described above. Embodiments described herein are able to generate these traffic levels efficiently and accurately in a manner that is reduces costs and computational intensity on a system, enabling embodiments to determine traffic levels along road segments in a cost effective manner.

Embodiments described herein collect probe data representing vehicle traffic along road segments to generate traffic pattern (TP) data and short-term traffic pattern (STP) data for the road segments of a road network. This TP data and STP data for road segments is used to reduce the volume of probe data and the frequency of probe data collection along road segments, while still producing accurate traffic data.

Historical probe data is collected and map-matched to road segments. The probe data is collected from mobile devices, vehicles, and other sources that can provide accurate reflections of the traffic volumes and speeds along road segments. Using the probe data that is map-matched to road segments, the vehicle speed and traffic volume data for each road segment can be established. This historical probe data is also associated with time periods or epochs, such that a context of the traffic speed and volume is known. For example, time periods can include time of day, day of the week, week of the year, etc. These times can reflect rush hour timeframes, weekend timeframes, holiday timeframes, etc. These time periods are important as traffic volumes and speeds along road segments is generally temporal and dynamic in nature. However, for a particular time period of a particular day of the week, the traffic volumes and speeds may be consistent, regardless of whether that consistency reflects heavy traffic or free-flowing traffic.

To understand the presence or absence of traffic congestion, it is imperative to understand the typical speed of traffic flow on a road or the designed traffic flow speed. Speed categories are defined for road segments based on a functional class of the road segment or type of road. Speed limits associated with road segments may not be ideal indicators of a typical speed on a road segment. Roads are designed with a design speed, an operating speed at which safe operation is conventionally possible, and a speed limit. Vehicles often travel in excess of the speed limit, particularly on certain categories or functional classes of road segments, such that speed categories are defined herein to accommodate ranges of speeds on various types of roads and functional classes of roads. Speed categories are defined for road segments using a threshold-based category associated with a functional class or type of road. For example, a limited-access expressway or highway may have a speed category of between 50 miles per hour (mph) and 75 mph. Optionally, there may be no upper-limit to a speed category, as above a predefined speed the flow of traffic on a road segment is considered unimpeded or substantially “free-flowing” traffic where vehicles travel at a speed desired by their operators.

Road functional classes may differ by country or region, but an example includes interstate roads, arterial roads, collector roads, and local roads. There may be more or fewer functional classes in some geographical areas. The highest functional class or “interstates” in the aforementioned examples may have a threshold speed of 50 mph, above which traffic is considered to be free-flow or unimpeded. Below the speed threshold of 50 mph traffic may be considered “queuing” or slowed by traffic congestion or other impediments. Another threshold speed below 50 mph, such as 20 mph, may be defined as the threshold below which traffic may be considered stationary. These thresholds differ based on the functional class of the road segment. For example, on a local road with speed limits around 20-30 mph, traffic speeds above 20 mph may be considered free flowing, while traffic below 10 mph may be considered stationary. Traffic between 10 mph and 20 mph may be considered queuing. Defining these speed category thresholds enables traffic congestion levels to be readily and accurately established along various types of roads and functional classes.

Using vehicle probe data including historical probe data described above along with the speed category thresholds for road segments, traffic pattern (TP) data and short-term traffic data (STP) is generated for roads of a road network, along with reliability index data for each road segment. The reliability index data may be generated based on a volume of probe data points and/or a consistency among the probe data points, such as not deviating substantially from one another along a road segment for a time period. For efficiency of data processing, road segments that are contiguous and in the same speed category having the same reliability index (or within a predefined degree of similarity) can be aggregated.

The road segments of the road network or aggregated contiguous road segments can be designated as TP road segments or STP road segments. Further, the assignment of TP road segments or STP road segments may be dynamic or temporally based. TP road segments are stable road segments where historical probe data and reliability data reflects consistency of traffic patterns along those road segments. Such TP road segments do not require high-frequency probe data collection along those segments as the traffic patterns along these stable road segments is highly predictable. Conversely, STP road segments or TP road segments with low reliability data may require higher frequency probe data collection to establish the traffic speeds on those road segments. These STP road segments are unstable road segments, where the traffic speeds are unpredictable and can differ from the historic probe data.

TP road segments and STP road segments represent both a road segment (e.g., via a road segment identifier or TMC identifier) and a relevant time. For example, many road segments may be designated at TP road segments in overnight hours, such as between midnight and 5:00 am, as traffic during that time is generally light and often very predictable. Thus, most road links may be stable TP road segments in those hours. Further, some road segments may be unstable during specific time windows of the day, such as traffic lanes inbound to a city in the morning and outbound in the evening. Road segments inbound to a city may become stable in an afternoon, while road segments outbound rom a city may be stable during morning hours. Road segments in a school zone may be stable most of the day, but become unstable during the time when school is starting and the time when school is ending. Thus, each road segment or aggregated contiguous road segments sharing the same properties can be given an identifier of a TP road segment or STP road segment depending upon the time of the day.

Based on the identification of road segments and aggregated road segments as TP (stable) or STP (dynamic, unstable), the road segments may be filtered for a real-time traffic processing engine. As detailed above, real-time traffic processing is computationally intensive and costly based on processing capacity required and bandwidth. Embodiments rely on the stability of the TP road segment and the historical traffic data on those road segments to avoid collection of real-time probe data on those segments.

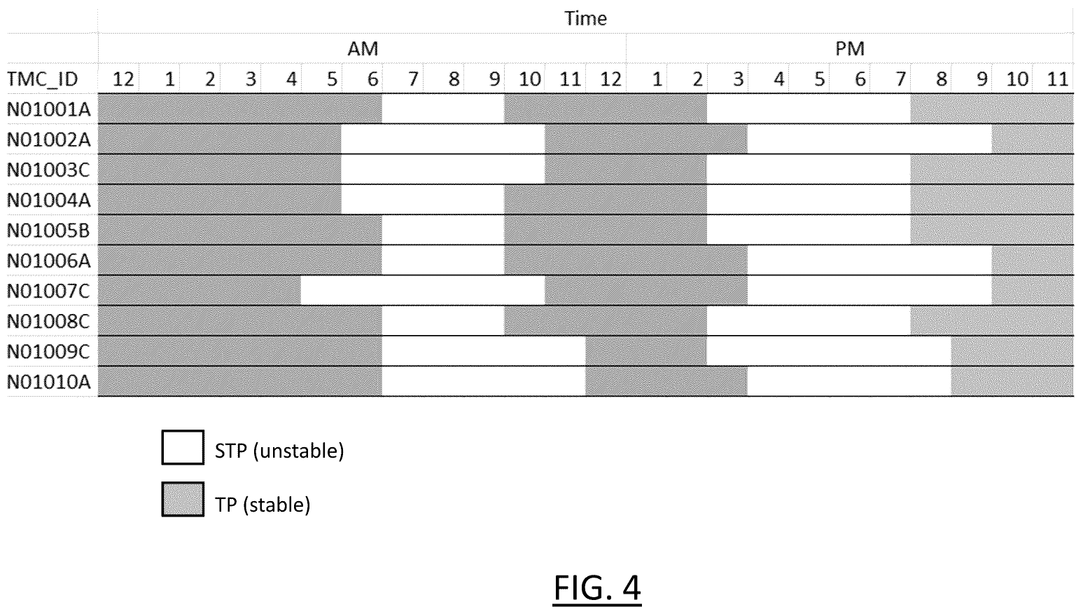

FIG. 4 illustrates a visual example of a single day for a plurality of road segments identified by their TMC_ID or TMC identifiers. The table illustrates the times of day when each road segment is a stable TP road segment versus an unstable STP road segment. While during the time periods where the road segments are stable, real time probe data aggregation does not need to take place, and historical traffic pattern data can be used to define traffic speeds along those road segments. During the unstable portions, which in the illustrated embodiment are morning rush hour times and afternoon rush hour times, real time probe data collection may be necessary to establish actual traffic patterns along those road segments. FIG. 4 does not reflect any segment aggregation which may be possible, such as if the road segments are of the same road functional class, contiguous, and having the same stability at any portion of time.

The determination of whether a road segment is stable or unstable may be performed periodically. As unstable road segments have probe data collected with relative frequency, at least during the times at which they are unstable, it can be relatively straightforward to analyze whether the road segments are indeed unstable during those times. A periodic verification of instability may be performed on road segments at times when they are unstable STP road segments. This periodic verification may be performed, for example, every three weeks to generate a new historical data profile for those road segment at that time and to determine an updated reliability index.

Confirming that road segments remain stable may be a longer process, as while a road segment is stable, probe data collection along those road segments may be very limited. As such, periodic updates may be performed, such as every fifteen weeks, to generate new traffic pattern (TP) data for a stable road segment to confirm whether or not those road segments remain stable at the previously stable time periods.

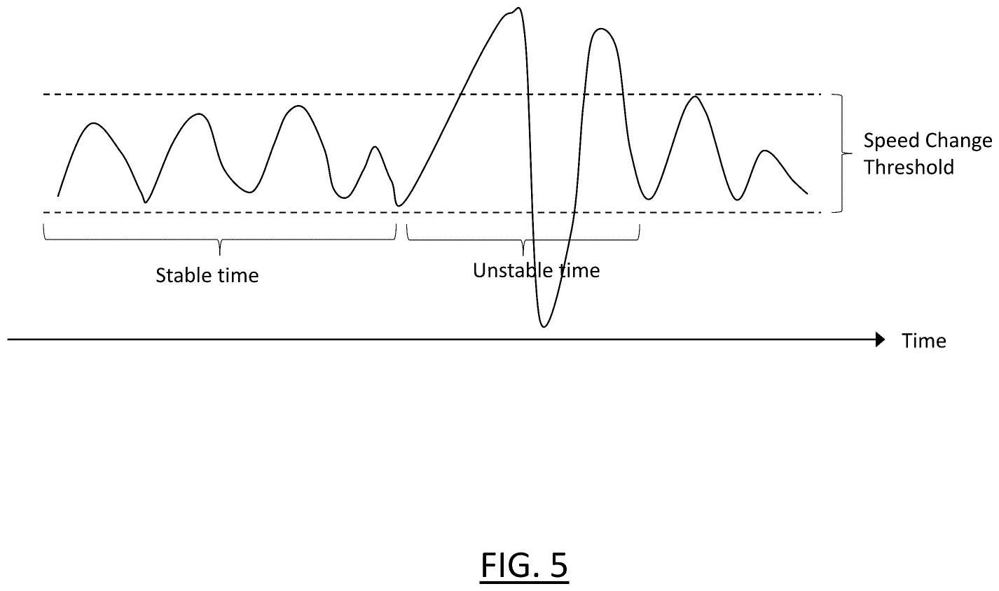

FIG. 5 illustrates a road segment that moves between a stable time to an unstable time. For each road segment, speeds along the road segment may be aggregated by time. The speed may be binned to one of several speed categories until a speed change is greater than a predefined speed threshold, where speed and time aggregation is stopped and started again to identify a new speed category. Speeds along a road segment for adjacent or continuous time periods that are within the same speed category can be aggregated together. A speed reliability index and short-term traffic pattern can be calculated for the shorter time period. This can be performed, for example, every three weeks to identify changes to the traffic patterns and to determine if a road link becomes stable. The same aggregation strategy can be applied to stable road segments, though the periodic update may be on the order of every fifteen weeks or so. Aggregated STP and TP data with the reliability index can be provided to a traffic processing engine as a filter, selectively processing road segments with less stable STP and TP data with low reliability.

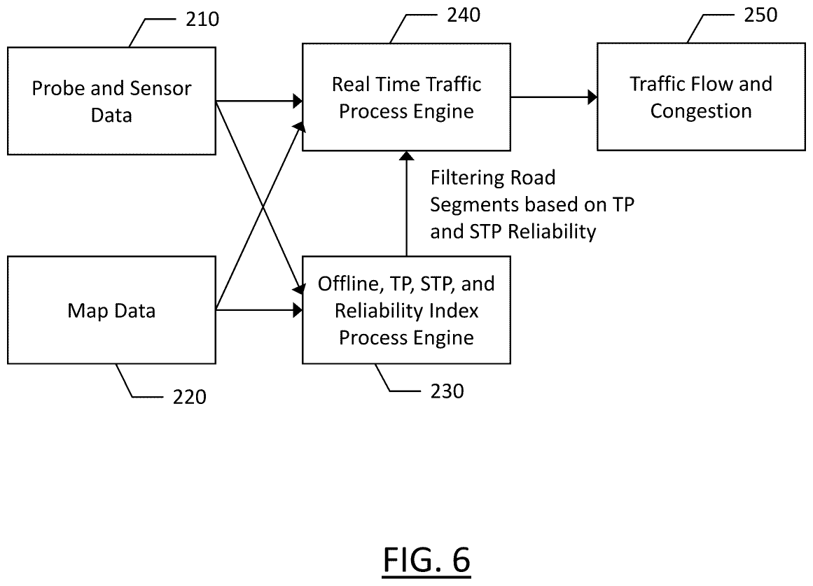

FIG. 6 illustrates an example embodiment of an intelligent traffic processing system employing the process described above for identifying stable (TP) and unstable (STP) road segments for improving the efficiency of traffic data processing. As shown, probe data and sensor data 210 is collected from vehicles and mobile devices that travel within a geographic area among a road network. Map data 220 associated with the road network is provided, such as from map database 110 of FIG. 3. The TP, STP, and Reliability Index Processing Engine 230 operates offline to establish road segments as stable (TP) or unstable (STP) along with the reliability index of each determination. The TP, STP, and Reliability information is provided along with the map data 220 and probe and sensor data 210 to the Real Time Traffic Processing Engine 240, which will collect and process probe data associated with unstable road segments that are filtered according to information from the TP, STP, and Reliability Index Processing Engine 230. The aggregated information is used to generate traffic flow and congestion at 250.

While the unstable road segments having short-term traffic pattern data receive real-time probe data to determine traffic patterns, the stable road segments having traffic pattern data do not receive real-time updates. Anomalies in traffic patterns occur that can disrupt traffic even on road segments that have generally stable traffic patterns that generally recur. These anomalies are addressed on stable road segments through other channels. For example, traffic accidents or road construction are events that are reported through event occurrence pipelines, such as through emergency response data sources for accidents or municipal data sources for road construction. The road segment anomalies can thus be handled outside of the process described herein to more accurately convey when traffic anomalies arise on the stable traffic pattern road segments.

Embodiments described herein analyze historical probe data for road segments to identify road segments that are stable and road segments that are unstable. Traffic pattern data is generated from historical probe data for stable road segments which are road segments during time periods where the traffic on the road segments is predictable. Short-term traffic pattern data is identified from historical probe data for unstable road segments which are road segments during time periods where the traffic on the road segments is unpredictable. This maps out a region with stable and unstable road segments. Real-time probe data is collected along the road network, and for those unstable road segments, the real-time probe data is collected for time periods associated with the unstable road segments along those unstable road segments. This real-time probe data is used to generate real-time traffic data along those unstable road segments at the time periods when they are deemed to be unstable. Conversely, for stable road segments during time periods when they are deemed to be stable, real-time probe data is not used, but historical probe data is used to estimate what the traffic levels are along those road segments. This process yields a substantial reduction in processing resources required and bandwidth required to determine traffic on the road network of a geographic region at any given time. This process further improves the performance of a navigational system, routing engine, and/or autonomous vehicle control such that it improves the performance of a computing device itself by limiting processing resources required while providing accurate and efficient traffic information.

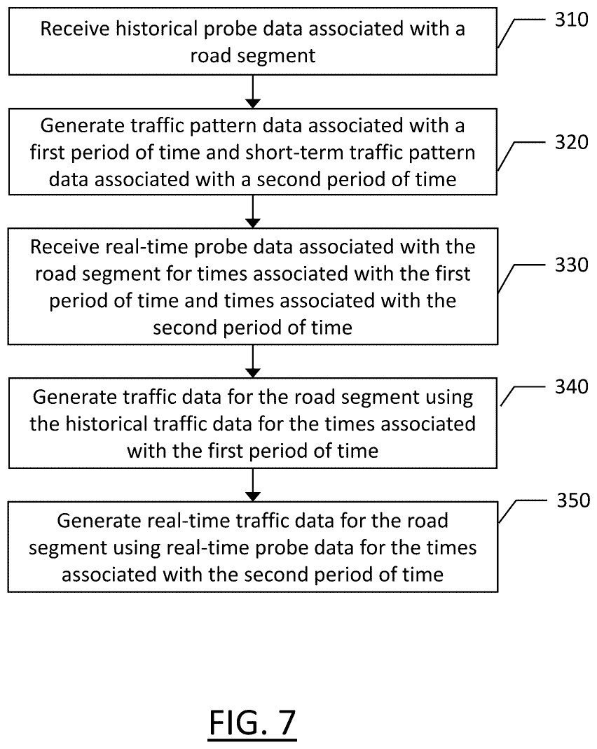

FIG. 7, described below, is a flowchart illustrative of methods according to example embodiments of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 26 of an apparatus employing an embodiment of the present invention and executed by a processor 24 of the apparatus 20. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 7 illustrates a method for establishing traffic patterns in an efficient manner as described above according to an example embodiment of the present disclosure. According to the illustrated embodiment, historical probe data associated with a road segment of a plurality of road segments within a road network of a geographic region are received at 310. Traffic pattern data associated with a first period of time and short-term traffic pattern data associated with a second period of time is generated at 320. Real-time probe data associated with the road segment for times associated with the first period of time and times associated with the second period of time are received at 330. Traffic data is generated at 340 for the road segment using the historical traffic data for the times associated with the first period of time. Real-time traffic data is generated at 350 for the road segment using real-time probe data for the times associated with the second period of time. The real-time traffic data and the traffic data for the road segment can then be used for at least one of navigational assistance, such as route guidance and route selection, or at least semi-autonomous vehicle control.

In an example embodiment, an apparatus for performing the method of FIG. 7 above may comprise a processor (e.g., the processor 24) configured to perform some or each of the operations (310-350) described above. The processor may, for example, be configured to perform the operations (310-350) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 310-350 may comprise, for example, the processor 24 and/or a device or circuit for executing instructions or executing an algorithm for processing information as described above.

1. An apparatus comprising at least one processor and at least one non-transitory memory including computer program code instructions, the computer program code instructions configured to, when executed, cause the apparatus to at least:
receive historical probe data associated with a road segment of a plurality of road segments of a road network within a geographic region;
generate, from the historical probe data, traffic pattern data and short-term traffic pattern data for a plurality of periods of time for the road segment, wherein the traffic pattern data comprises traffic patterns that are consistent with historical traffic patterns along the road segment during a first period of time of the plurality of periods of time, and wherein short-term traffic pattern data comprises traffic patterns that fluctuate relative to historical traffic patterns along the road segment during a second period of time;
receive real-time probe data associated with the road segment of the road network during times associated with the first period of time and times associated with the second period of time;
generate traffic data for the road segment using historical traffic pattern data for the times associated with the first period of time; and
generate real-time traffic data for the road segment using the real-time probe data received during the times associated with the second period of time, wherein the traffic data and the real-time traffic data facilitate at least one of navigational guidance or at least semi-autonomous vehicle control along the road segment.

2. The apparatus of claim 1, wherein causing the apparatus to generate real-time traffic data for the road segment using the real-time probe data received during the times associated with the second period of time comprises causing the apparatus to filter out real-time probe data associated with the first period of time associated with the traffic pattern data.

3. The apparatus of claim 1, wherein the apparatus is further caused to:
determine a reliability index of the traffic pattern data and a reliability index of the short-term traffic pattern data; and
in response to the reliability index of the traffic pattern data being below a predetermined value, generate the traffic data for the road segment using the real-time probe data received during the times associated with the first period of time.

4. The apparatus of claim 3, in response to the reliability index of the traffic pattern data being below the predetermined value, the apparatus is further caused to regenerate the traffic pattern data for the first period of time.

5. The apparatus of claim 1, wherein the probe data associated with the road segment is map-matched to the road segment of the plurality of road segments.

6. The apparatus of claim 1, wherein the apparatus is further caused to:
determine at least one speed category for the road segment for each of the plurality of periods of time, wherein the traffic pattern data comprises probe data for time periods of the plurality of periods of time that corresponds with the at least one speed category for a corresponding historical time period, and the short-term traffic pattern data comprises probe data for time periods of the plurality of periods of time that does not correspond with the at least one speed category for a corresponding historical time period.

7. The apparatus of claim 6, wherein the at least one speed category is determined based, at least in part, on at least one of a road type or a road functional class.

8. The apparatus of claim 1, wherein the traffic pattern data for the road segment and the short-term traffic pattern data for the road segment each comprise a reliability index.

9. The apparatus of claim 8, wherein the reliability index is an indication of confidence that the traffic pattern data or the short-term traffic pattern data is an accurate reflection of historical stability of traffic patterns on the road segment.

10. The apparatus of claim 1, wherein causing the apparatus to generate the traffic pattern data and the short-term traffic pattern data comprises aggregating continuous periods of time for the road segment for each of the traffic pattern data and the short-term traffic pattern data.

11. A computer program product comprising at least one non-transitory computer-readable storage medium having computer-executable program code instructions stored therein, the computer-executable program code instructions comprising program code instructions to:
receive historical probe data associated with a road segment of a plurality of road segments of a road network within a geographic region;
generate, from the historical probe data, traffic pattern data and short-term traffic pattern data for a plurality of periods of time for the road segment, wherein the traffic pattern data comprises traffic patterns that are consistent with historical traffic patterns along the road segment during a first period of time of the plurality of periods of time, and wherein short-term traffic pattern data comprises traffic patterns that fluctuate relative to historical traffic patterns along the road segment during a second period of time;
receive real-time probe data associated with the road segment of the road network during times associated with the first period of time and times associated with the second period of time;
generate traffic data for the road segment using historical traffic pattern data for the times associated with the first period of time; and
generate real-time traffic data for the road segment using the real-time probe data received during the times associated with the second period of time, wherein the traffic data and the real-time traffic data facilitate at least one of navigational guidance or at least semi-autonomous vehicle control along the road segment.

12. The computer program product of claim 11, wherein the probe data associated with the road segment is map-matched to the road segment of the plurality of road segments.

13. The computer program product of claim 11, further comprising program code instructions to:
determine at least one speed category for the road segment for each of the plurality of periods of time, wherein the traffic pattern data comprises probe data for time periods of the plurality of periods of time that corresponds with the at least one speed category for a corresponding historical time period, and the short-term traffic pattern data comprises probe data for time periods of the plurality of periods of time that does not correspond with the at least one speed category for a corresponding historical time period.

14. The computer program product of claim 13, wherein the at least one speed category is determined based, at least in part, on at least one of a road type or a road functional class.

15. The computer program product of claim 11, wherein the traffic pattern data for the road segment and the short-term traffic pattern data for the road segment each comprise a reliability index.

16. The computer program product of claim 15, wherein the reliability index is an indication of confidence that the traffic pattern data or the short-term traffic pattern data is an accurate reflection of historical stability of traffic patterns on the road segment.

17. The computer program product of claim 11, wherein the program code instructions to generate the traffic pattern data and the short-term traffic pattern data comprises program code instructions to aggregate continuous periods of time for the road segment for each of the traffic pattern data and the short-term traffic pattern data.

18. A method comprising:
receiving historical probe data associated with a road segment of a plurality of road segments of a road network within a geographic region;
generating, from the historical probe data, traffic pattern data and short-term traffic pattern data for a plurality of periods of time for the road segment, wherein the traffic pattern data comprises traffic patterns that are consistent with historical traffic patterns along the road segment during a first period of time of the plurality of periods of time, and wherein short-term traffic pattern data comprises traffic patterns that fluctuate relative to historical traffic patterns along the road segment during a second period of time;
receiving real-time probe data associated with the road segment of the road network during times associated with the first period of time and times associated with the second period of time;
generating traffic data for the road segment using historical traffic pattern data for the times associated with the first period of time; and
generating real-time traffic data for the road segment using the real-time probe data received during the times associated with the second period of time, wherein the traffic data and the real-time traffic data facilitate at least one of navigational guidance or at least semi-autonomous vehicle control along the road segment.

19. The method of claim 18, wherein the probe data associated with the road segment is map-matched to the road segment of the plurality of road segments.

20. The method of claim 18, further comprising:
determining at least one speed category for the road segment for each of the plurality of periods of time, wherein the traffic pattern data comprises probe data for time periods of the plurality of periods of time that corresponds with the at least one speed category for a corresponding historical time period, and the short-term traffic pattern data comprises probe data for time periods of the plurality of periods of time that does not correspond with the at least one speed category for a corresponding historical time period.
